(19) United States
(12) Patent Application Publication
(10) Pub. No.: US 2013/0067307 A1
(43) Pub. Date: Mar. 14, 2013

(54) USER INTERFACE FOR TRANSLATION WEBPAGE

(71) Applicants: Chao Tian, Shanghai (CN); Awaneesh Verma, Mountain View, CA (US); Joshua James Estelle, San Francisco, CA (US); Yung-Fong Frank Tang, Sunnyvale, CA (US)

(72) Inventors: Chao Tian, Shanghai (CN); Awaneesh Verma, Mountain View, CA (US); Joshua James Estelle, San Francisco, CA (US); Yung-Fong Frank Tang, Sunnyvale, CA (US)

(73) Assignee: GOOGLE INC., Mountain View, CA (US)

(21) Appl. No.: 13/305,895

(22) Filed: Nov. 29, 2011

Related U.S. Application Data
(63) Continuation of application No. PCT/CN2011/079504, filed on Sep. 9, 2011.

(51) Int. Cl. G06F 3/048; G06F 17/00

(52) U.S. Cl. 715/222

(57) ABSTRACT

A computer-implemented technique includes receiving a request for a translation webpage and generating a user interface webpage for the translation webpage. The user interface webpage includes a text input portion, a translated text output portion, a source language selection portion, and a target language selection portion. The source language selection portion includes a quick source language selection icon identifying a potential source language, and a source language selection list including a plurality of potential source languages. The target language selection portion includes a quick target language selection icon identifying a potential target language, and a target language selection list including a plurality of potential target languages. The potential source language and the potential target language is determined based on a stored history of a user, which includes at least one of preferences of the user, source languages previously selected by the user, and target languages previously selected by the user.

### CROSS-REFERENCE TO RELATED APPLICATION

This application is a continuation of International Application No. PCT/CN2011/079504 filed on Sep. 9, 2011. The entire disclosure of the above application is incorporated herein by reference.

### FIELD

The present disclosure relates to a user interface for a translation webpage.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A user may access a website from a computing device via a network such as the Internet. The website may display a webpage to the user via a web browser executing on the computing device. The webpage may include images, videos, text, or a combination thereof, to be displayed to the user on a display associated with the computing device. The webpage may provide a user interface through which the user interacts with the network and the computing devices connected thereto (servers, routers, etc.). Accordingly, the user interface provided by a webpage may provide a simple mechanism for the user to accomplish whatever tasks the user wishes to perform.

### SUMMARY

This section provides a general summary of the disclosure, and is not a comprehensive disclosure of its full scope or all of its features.

In various embodiments of the present disclosure, a computer-implemented technique is disclosed. The technique can include receiving, at a server, a request for a translation webpage from a user interacting with a user device to initiate a user session. The technique can also include generating, at the server, a user interface webpage for the translation webpage, where the user interface webpage includes: (i) a text input portion, (ii) a translated text output portion, (iii) a source language selection portion, and (iv) a target language selection portion. The source language selection portion may include: (a) a quick source language selection icon identifying a first potential source language, and (b) a source language selection list including a plurality of potential source languages. Similarly, the target language selection portion may include: (a) a quick target language selection icon identifying a first potential target language, and (b) a target language selection list including a plurality of potential target languages. The technique may further include determining the potential source language and the potential target language based on a stored history of the user. The stored history may include at least one of: (i) preferences of the user, (ii) source languages previously selected by the user, and (iii) target languages previously selected by the user. Additionally, the technique may include providing, from the server, the user interface webpage to the user device and receiving, at the server, a translation request from the user interacting with the user interface webpage displayed at the user device. The translation request can include a text portion in a source language, a source language identification that identifies the source language, and a target language identification that identifies a target language in which the user desires to have the text portion translated. The technique may also include providing a translated text output to the user device based on the translation request. The translated text output may correspond to a translation of the text portion from the source language to the target language. Finally, the technique may include updating the stored history based on the source language identification and the target language identification such that the source language selection portion and the target language selection portion dynamically update during the user session.

In various embodiments of the present disclosure, a computer-implemented technique is disclosed. The technique can include receiving, at a server, a request for a translation webpage from a user interacting with a user device. The technique can further include generating, at the server, a user interface webpage for the translation webpage, the user interface webpage including: (i) a text input portion, (ii) a translated text output portion, (iii) a source language selection portion, and (iv) a target language selection portion. The source language selection portion may include: (a) a quick source language selection icon identifying a potential source language, and (b) a source language selection list including a plurality of potential source languages. Similarly, the target language selection portion may include: (a) a quick target language selection icon identifying a potential target language, and (b) a target language selection list including a plurality of potential target languages. The technique can also include determining the potential source language and the potential target language based on a stored history of the user. The stored history of the user can include at least one of: (i) preferences of the user, (ii) source languages previously selected by the user, and (iii) target languages previously selected by the user.

In various embodiments of the present disclosure, a computer-implemented technique may utilize a server that includes a communication module, a user interface module and a datastore. The communication module may receive a request for a translation webpage from a user interacting with a user device. The user interface module may be in communication with the communication module and may generate a user interface webpage for the translation webpage. The user interface webpage can include: (i) a text input portion, (ii) a translated text output portion, (iii) a source language selection portion, and (iv) a target language selection portion. The source language selection portion may include: (a) a quick source language selection icon identifying a potential source language, and (b) a source language selection list including a plurality of potential source languages. Similarly, the target language selection portion can include: (a) a quick target language selection icon identifying a potential target language, and (b) a target language selection list including a plurality of potential target languages. The datastore may be in communication with the user interface module and may store a stored history of the user including at least one of: (i) preferences of the user, (ii) source languages previously selected by the user, and (iii) target languages previously selected by the user. The user interface module may determine the potential source language and the potential target language based on the stored history of the user.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic diagram of an example server according to some embodiments of the present disclosure and an example environment in which techniques according to some embodiments of the present disclosure can be utilized;

FIG. 2 is a schematic block diagram of the example server of FIG. 1;

FIG. 3 is a representation of an example user interface according to some embodiments of the present disclosure;

FIG. 4 is a representation of the example user interface of FIG. 3 in an expanded state;

FIG. 5 is a flow diagram of an example of a technique according to some embodiments of the present disclosure; and

FIG. 6 is a flow diagram of the example technique for generating a user interface webpage of FIG. 5.

### DETAILED DESCRIPTION

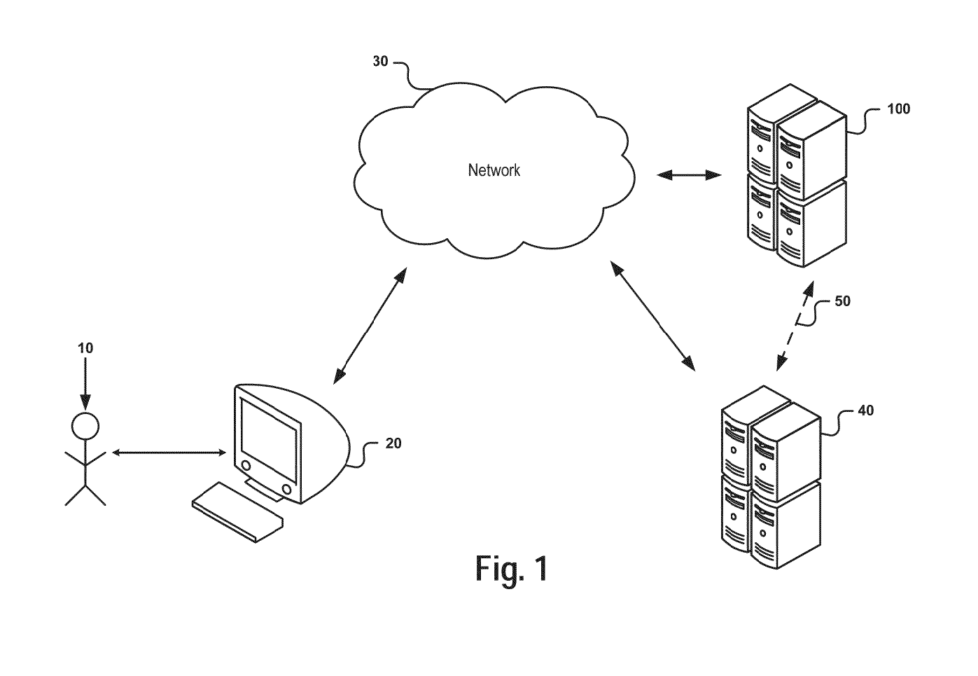

Referring now to FIG. 1, an environment in which the techniques according to some embodiments of the present disclosure can be utilized is illustrated. A user 10 can interact with a user device 20, for example, to access a network 30. Examples of the network 30 include, but are not limited to, the Internet, a wide area network, a local area network, and a private network. A server 100 connected to the network 30 may also be accessed by the user 10 via a user device 20. Further, in some embodiments of the present disclosure, a translation engine 40 may be connected to network 30 and/or connected to the server 100 through a separate communication connection 50. One skilled in the art will appreciate that the environment shown in FIG. 1 is merely illustrative and different environments (such as those that include more or less components, those that include additional connections, and/or those that are arranged in a different configuration) may be utilized with the present disclosure. For example only, while the translation engine 40 is illustrated in FIG. 1 as being separate from the server 100, one will appreciate that the translation engine 40 may be included as a module, engine, etc. of the server 100.

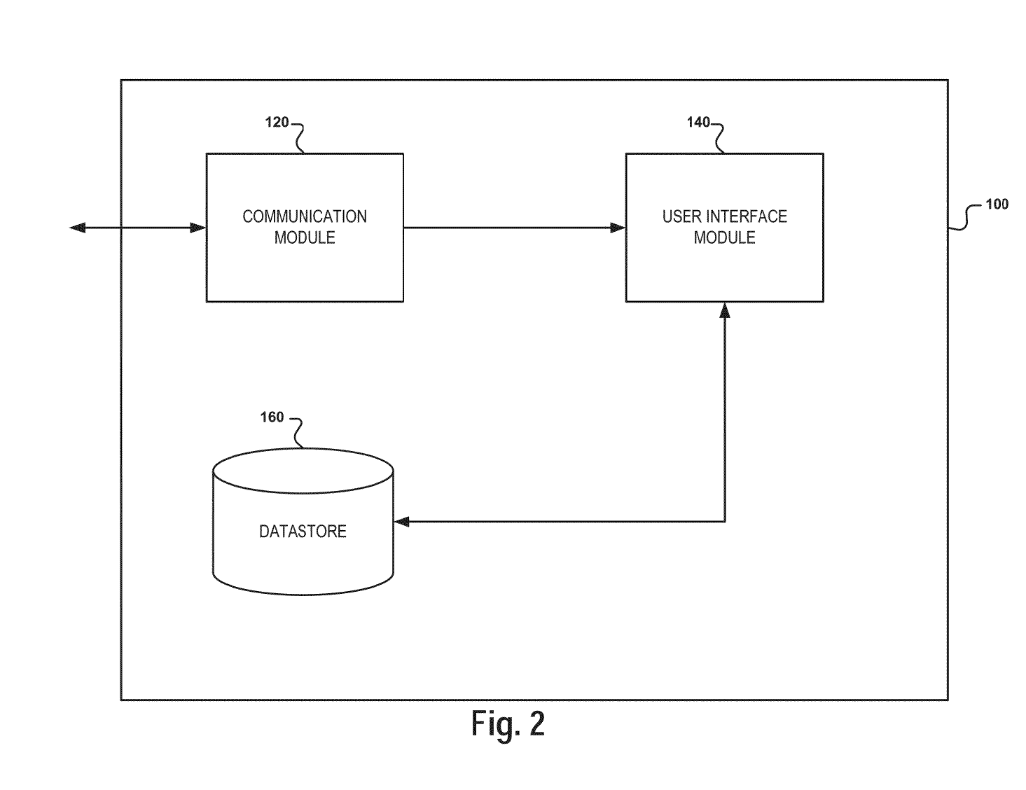

A block diagram of an example server 100 according to some embodiments of the present disclosure is illustrated in FIG. 2. The server 100 includes a communication module 120 in communication with a user interface module 140, as well as a datastore 160 in communication with the user interface module 140. The communication module 120 can provide the communication interface between the server 100 and the user 10 and user device 20 via network 30, as well as between the server 100 and the translation engine 40 via either the network 30 or separate communication connection 50.

In some embodiments, the communication module 120 may receive a request for a translation webpage from the user 10 interacting with the user device 20 via network 30. A translation webpage includes, for example, a webpage that provides a user interface through which the user 10 interacts with a component (such as translation engine 40) that provides a translation service. The user interface for the translation webpage may be generated by the user interface module 140, e.g., according to the techniques described below.

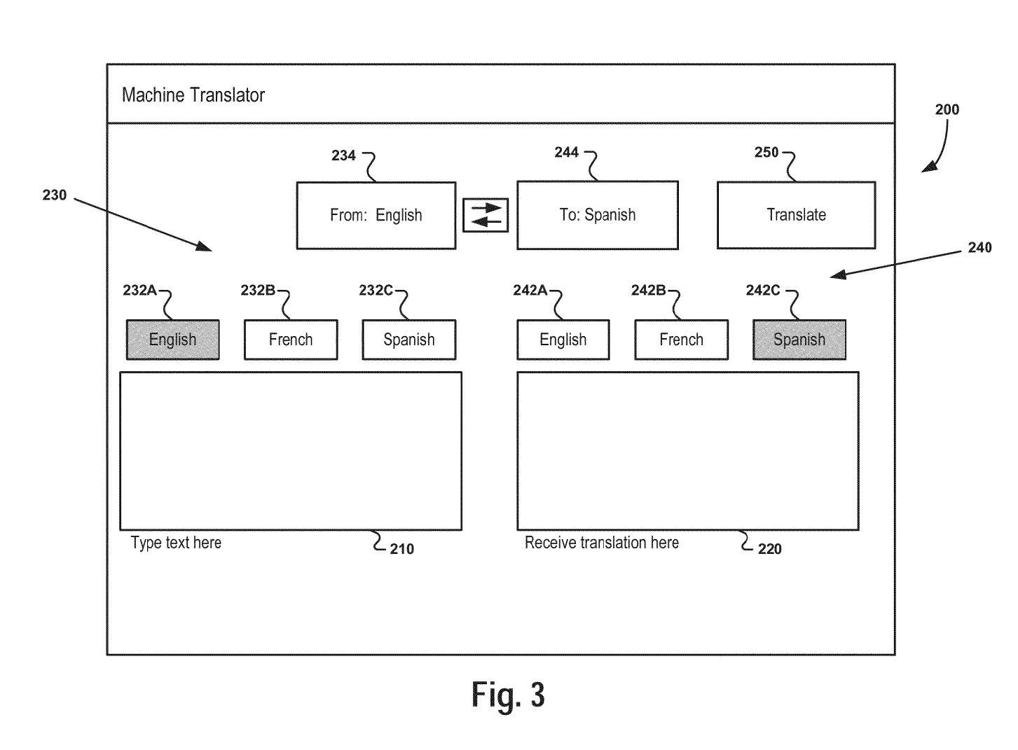

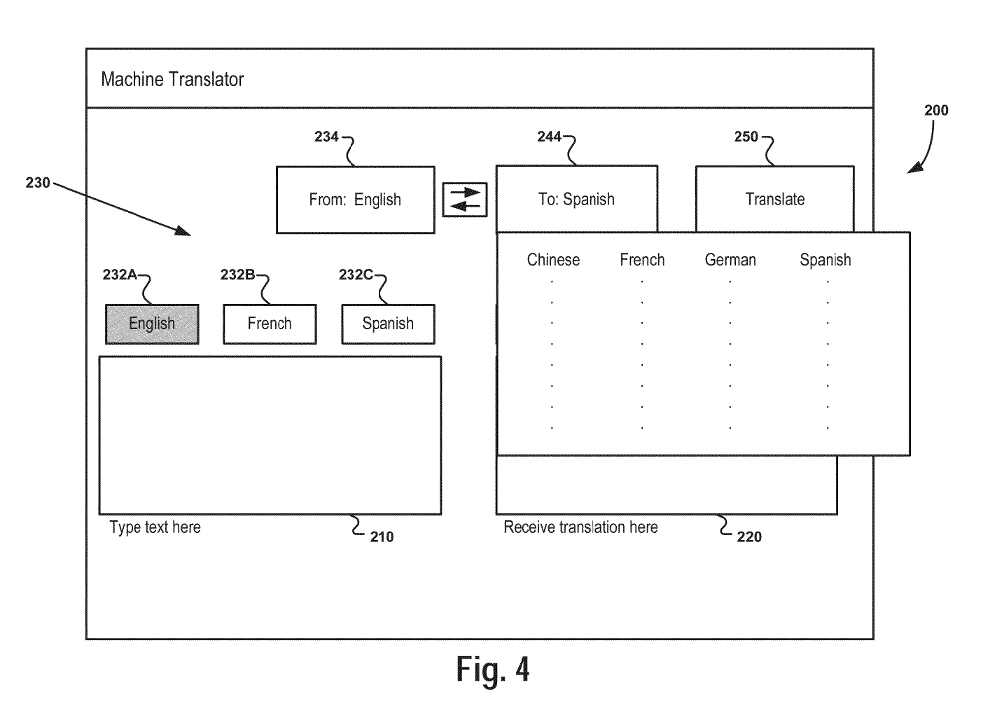

An example of a user interface 200 according to some embodiments of the present disclosure is shown in FIGS. 3 and 4. The user interface 200 can include a text input portion 210, a translated text output portion 220, a source language selection portion 230 and a target language selection portion 240. The text input portion 210 may be selected by the user 10, such as by being “clicked” by the user 10 interacting with a web browser on the user device 20. A text portion to be translated may be entered into the text input portion by the user 10 by any known manner.

Further, the user 10 can select a source language (that is, the original language of the text portion) and a target language (that is, the language in which the user 10 desires the text portion to be translated) via the source language selection portion 230 and the target language selection portion 240, respectively. Upon receipt of a translation command (such as, by the user 10 selecting a translate command icon 250), a translated text output can be generated (e.g., by translation engine 40) and provided to the user 10 by being displayed in the translated text output portion 220 of the user interface 200. The translated text output may correspond to a translation (machine or otherwise) of the text portion from the source language to the target language.

The source language selection portion 230 can include one or more quick source language selection icons 232A, 232B and 232C. Each of the quick source language selection icons 232A, 232B and 232C identifies a potential source language. Further, the source language selection portion 230 can include a source language selection list 234 that includes a plurality of potential source languages. Similarly, the target language selection portion 240 can include one or more quick target language selection icons 242A, 242B and 242C (each of which identifying a potential target language) and a target language selection list 244 that includes a plurality of potential target languages. In various embodiments, the quick source and target language selection icons 232, 242 may be click buttons, radio buttons, selectable tabs on the text input portion and translate text output portion, respectively, or a combination thereof.

Each of the source language selection list 234 and the target language selection list 244 can be individually displayed in the user interface 200 in a collapsed state (FIG. 3) or an expanded state (FIG. 4). These lists may be toggled between the collapsed and expanded state by the user 10, e.g., by clicking on the appropriate list. In the collapsed state (FIG. 3) the source and target language selection lists 234, 244 may display only a selected source or target language, respectively, while in the expanded state (FIG. 4) the source and target language selection lists 234, 244 may display a plurality of potential source and target languages, respectively.

The specific potential source and target languages identified by the quick source language selection icons 232A, 232B and 232C and the quick target language selection icons 242A, 242B and 242C can be determined in many ways. In some embodiments, the specific potential source and target languages identified by the quick source language selection icons 232 and the quick target language selection icons 242 can be determined based on a stored history of the user 10, for example, stored in the datastore 160. The datastore 160 may include, e.g., a database, a hard disk drive, flash memory, server memory or any other type of electronic storage medium.

The stored history of the user 10 can include: (1) preferences of the user 10 (previously selected by the user 10, determined from previous interactions with the server 100, or a combination of both), (2) one or more source languages previously selected by the user 10, and/or (3) one or more target languages previously selected by the user 10. In various embodiments of the present disclosure, the stored history of the user 10 may also include N source languages most recently selected by the user 10 and M target languages most recently selected by the user 10, where M and N are integers greater than zero. In this manner, the user interface 200 may include N quick source language selection icons 232 (each of which identifying one of the N source languages most recently selected by the user 10) and M quick target language selection icons 242 (each of which identifying one of the M target languages most recently selected by the user 10). For example only, and as shown in FIGS. 3 and 4, the integers N and M may be equal to three such that there are three quick source language selection icons 232A, 232B and 232C and three quick target language selection icons 242A, 242B, and 242C.

The stored history of the user 10 may also include a ranking of frequency of use of the source languages previously selected by the user 10 and/or a ranking of frequency of use of the target languages previously selected by the user 10 such that the specific potential source and target languages identified by the quick source language selection icons 232 and the quick target language selection icons 242 can be determined based on these frequencies. In addition to the stored history of the user 10, in some embodiments the specific potential source and target languages identified by the quick source language selection icons 232 and the quick target language selection icons 242 can be determined based on a location of the user 10 and/or a web browser language setting located at the user device 20. The location of the user 10 can be determined in any known manner, such as through the use of geo-location or a Global Positioning System signal.

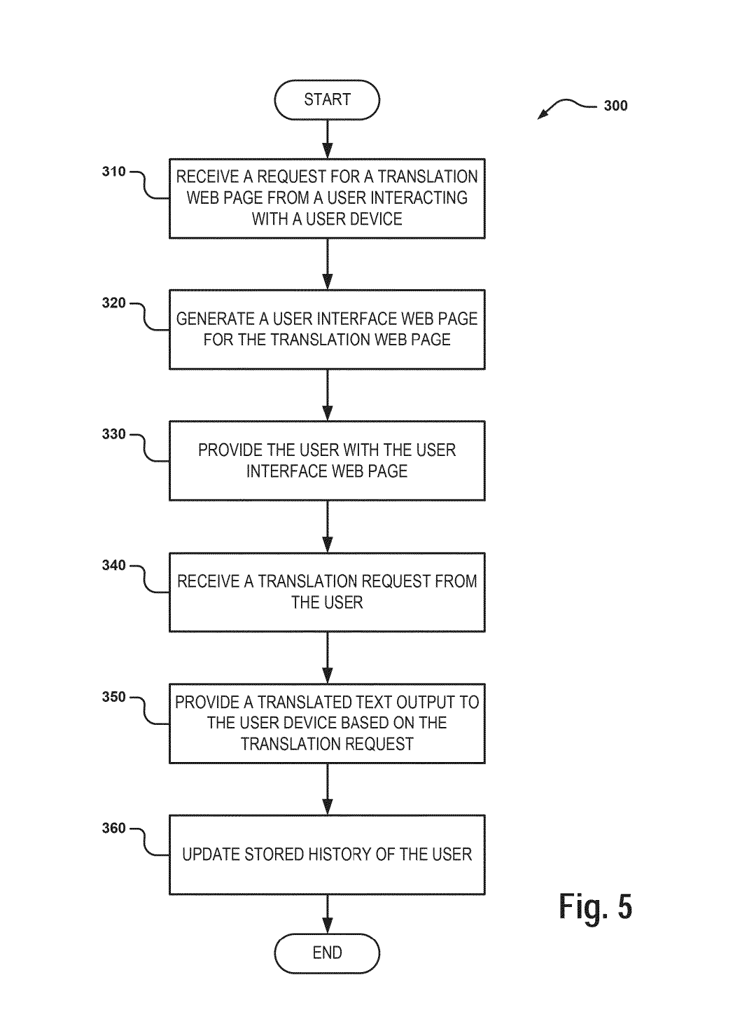

Referring now to FIG. 5, a flow chart describing an example technique (or method) 300 according to some embodiments of the present disclosure is shown. At step 310, a request for a translation webpage is received from the user 10 interacting with the user device 20 to initiate a user session. For example only, the server 100 (or more specifically, the communication module 120) may receive this request via the network 30. At step 320, a user interface webpage for the translation webpage is generated, e.g., by the server 100 (or more specifically, the user interface module 140). The user interface webpage may include, for example, the user interface 200 described above, and be provided to the user 10 at step 330.

A translation request is received from the user 10 at step 340, e.g., via the user interface 200 and user interface webpage and at the server 100 (or more specifically, the communication module 120). In some embodiments, the translation request includes: (1) a text portion in a source language, (2) a source language identification that identifies the source language of the text portion, and (3) a target language identification that identifies a target language in which the user 10 desires to have the text portion translated. At step 350, a translated text output is provided to the user 10/user device 20 based on the translation request. In some embodiments, the translated text output corresponds to a translation of the text portion from the identified source language to the identified target language.

At step 360, the stored history of the user 10, which can be utilized to generate the user interface 200 as described herein, is updated at the server 100, e.g., at the user interface module 140 and the datastore 160. The stored history may, for example, be updated based on the source and target language identifications in the translation request. Further, the stored history may be updated and utilized to dynamically update the source language selection portion (the quick source language selection icons 232, etc.) and/or the target language selection portion (the quick target language selection icons 242, etc.) during the user session, e.g., without the user 10 reloading the user interface webpage at the web browser on the user device 20. This may be accomplished through the use of JavaScript or similar mechanism.

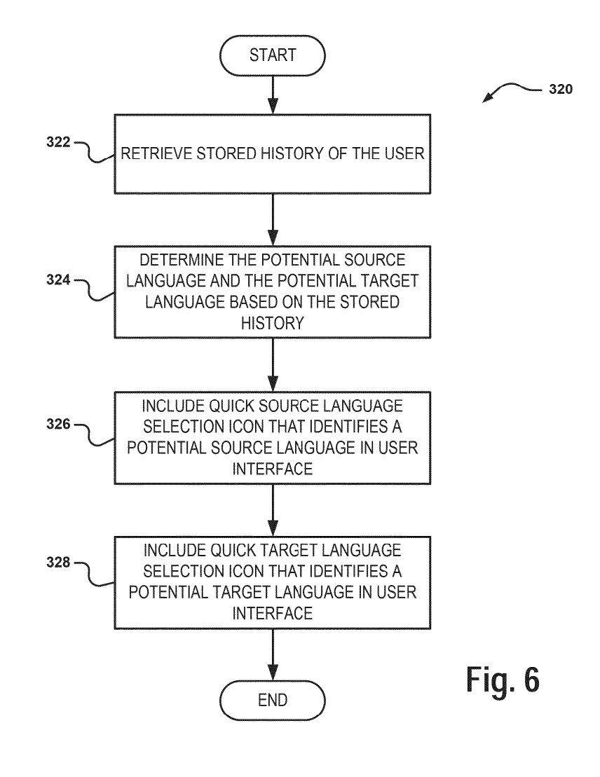

Referring now to FIG. 6, a flow chart describing an example technique (or method) for generating a user interface webpage (such as that described above in accordance with step 320) according to some embodiments of the present disclosure is shown. At step 322, the stored history of the user 10 is retrieved, e.g., by the user interface module 140. As discussed above, the stored history may be stored on the datastore 160 and utilized to generate the user interface 200.

At step 324, a potential source language and a potential target language are determined based on the stored history. At step 326, one or more quick source language selection icons 232 that each identifies one potential source language are included in the user interface 200. Similarly, at step 328, one or more quick target language selection icons 242 that each identifies one potential target language are included in the user interface 200. As described above, the specific potential source and target languages identified by the quick source and target language selection icons 232 and 242, respectively, can be determined in many ways. In some embodiments, the specific potential source and target languages identified by the quick source language selection icons 232 and the quick target language selection icons 242 can be determined based on a stored history of the user 10, for example, stored in the datastore 160.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the term module may refer to, be part of, or include an Application Specific Integrated Circuit (ASIC); an electronic circuit; a combinational logic circuit; a field programmable gate array (FPGA); a processor (shared, dedicated, or group) that executes code, or a process executed by a distributed network of processors and storage in networked clusters or datacenters; other suitable components that provide the described functionality; or a combination of some or all of the above, such as in a system-on-chip. The term module may include memory (shared, dedicated, or group) that stores code executed by the one or more processors.

The term code, as used above, may include software, firmware, byte-code and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein, and any references to specific languages are provided for disclosure of enablement and best mode of the present disclosure.

The present disclosure is well suited to a wide variety of computer network systems over numerous topologies. Within this field, the configuration and management of large networks comprise storage devices and computers that are communicatively coupled to dissimilar computers and storage devices over a network, such as the Internet.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method comprising:
receiving, at a server, a request for a translation webpage from a user interacting with a user device to initiate a user session;
generating, at the server, a user interface webpage for the translation webpage, the user interface webpage including: (i) a text input portion, (ii) a translated text output portion, (iii) a source language selection portion, and (iv) a target language selection portion,
wherein the source language selection portion includes: (a) a quick source language selection icon identifying a first potential source language, and (b) a source language selection list including a plurality of potential source languages, and
wherein the target language selection portion includes (a) a quick target language selection icon identifying a first potential target language, and (b) a target language selection list including a plurality of potential target languages;
determining the potential source language and the potential target language based on a stored history of the user, the stored history including at least one of: (i) preferences of the user, (ii) source languages previously selected by the user, and (iii) target languages previously selected by the user;
providing, from the server, the user interface webpage to the user device;
receiving, at the server, a translation request from the user interacting with the user interface webpage displayed at the user device, the translation request including a text portion in a source language, a source language identification that identifies the source language, and a target language identification that identifies a target language in which the user desires to have the text portion translated;
providing a translated text output to the user device based on the translation request, the translated text output corresponding to a translation of the text portion from the source language to the target language; and
updating the stored history based on the source language identification and the target language identification such that the source language selection portion and the target language selection portion dynamically update during the user session.

2. A computer-implemented method comprising:
receiving, at a server, a request for a translation webpage from a user interacting with a user device;
generating, at the server, a user interface webpage for the translation webpage, the user interface webpage including: (i) a text input portion, (ii) a translated text output portion, (iii) a source language selection portion, and (iv) a target language selection portion,
wherein the source language selection portion includes: (a) a quick source language selection icon identifying a potential source language, and (b) a source language selection list including a plurality of potential source languages, and
wherein the target language selection portion includes (a) a quick target language selection icon identifying a potential target language, and (b) a target language selection list including a plurality of potential target languages; and
determining the potential source language and the potential target language based on a stored history of the user, the stored history including at least one of: (i) preferences of the user, (ii) source languages previously selected by the user, and (iii) target languages previously selected by the user.

3. The computer-implemented method of claim 2 further comprising:
providing, from the server, the user interface webpage to the user device;
receiving, at the server, a translation request from the user interacting with the user interface webpage displayed at the user device, the translation request including a text portion in a source language, a source language identification that identifies the source language, and a target language identification that identifies a target language in which the user desires to have the text portion translated; and
providing a translated text output to the user device based on the translation request, the translated text output corresponding to a translation of the text portion from the source language to the target language.

4. The computer-implemented method of claim 2, further comprising updating the stored history such that the source language selection portion and the target language selection portion dynamically update during a user session.

5. The computer-implemented method of claim 2, wherein the quick source language selection icon and the quick target language selection icon comprise click buttons.

6. The computer-implemented method of claim 2, wherein the quick source language selection icon and the quick target language selection icon comprise radio buttons.

7. The computer-implemented method of claim 2, wherein the quick source language selection icon and the quick target language selection icon comprise selectable tabs on the text input portion and translated text output portion, respectively.

8. The computer-implemented method of claim 2, wherein (i) the stored history includes N source languages most recently selected by the user and M target languages most recently selected by the user, N and M being integers greater than zero, (ii) the source language selection portion includes N quick source language selection icons each corresponding to one of the N source languages most recently selected by the user, and (iii) the target language selection portion includes M quick target language selection icons each corresponding to one of the M target languages most recently selected by the user.

9. The computer-implemented method of claim 8, wherein N and M are equal to three.

10. The computer-implemented method of claim 2, wherein the stored history includes a first ranking of frequency of use of the source languages previously selected by the user, and a second ranking of frequency of use of the target languages previously selected by the user, wherein determining the potential source language and the potential target language is further based on the first and second rankings.

11. The computer-implemented method of claim 2, wherein the source language selection list displays only one of the plurality of potential source languages in a collapsed state and displays the plurality of potential source languages in an expanded state, and wherein the target language selection list displays only one of the plurality of potential target languages in the collapsed state and displays the plurality of potential target languages in the expanded state.

12. The computer-implemented method of claim 2, wherein determining the potential source language and the potential target language is further based on a location of the user.

13. The computer-implemented method of claim 2, wherein determining the potential source language and the potential target language is further based on a web browser language setting at the user device.

14. A system for generating a user interface webpage for a translation webpage comprising:
a communication module in a server that receives a request for a translation webpage from a user interacting with a user device;
a user interface module in the server and in communication with the communication module that generates a user interface webpage for the translation webpage, the user interface webpage including: (i) a text input portion, (ii) a translated text output portion, (iii) a source language selection portion, and (iv) a target language selection portion,
wherein the source language selection portion includes: (a) a quick source language selection icon identifying a potential source language, and (b) a source language selection list including a plurality of potential source languages, and
wherein the target language selection portion includes (a) a quick target language selection icon identifying a potential target language, and (b) a target language selection list including a plurality of potential target languages; and
a datastore in the server and in communication with the user interface module, the datastore storing a stored history of the user including at least one of: (i) preferences of the user, (ii) source languages previously selected by the user, and (iii) target languages previously selected by the user,
wherein the user interface module determines the potential source language and the potential target language based on the stored history of the user.

15. The system of claim 14, wherein the user interface module updates the stored history such that the source language selection portion and the target language selection portion dynamically update during a user session.

16. The system of claim 14, wherein (i) the stored history includes N source languages most recently selected by the user and M target languages most recently selected by the user, N and M being integers greater than zero, (ii) the source language selection portion includes N quick source language selection icons each corresponding to one of the N source languages most recently selected by the user, and (iii) the target language selection portion includes M quick target language selection icons each corresponding to one of the M target languages most recently selected by the user.

17. The system of claim 14, wherein the stored history includes a first ranking of frequency of use of the source languages previously selected by the user, and a second ranking of frequency of use of the target languages previously selected by the user, wherein determining the potential source language and the potential target language is further based on the first and second rankings.

18. The system of claim 14, wherein the source language selection list displays only one of the plurality of potential source languages in a collapsed state and displays the plurality of potential source languages in an expanded state, and wherein the target language selection list displays only one of the plurality of potential target languages in the collapsed state and displays the plurality of potential target languages in the expanded state.

19. The system of claim 14, wherein the user interface module further determines the potential source language and the potential target language based on a location of the user.

20. The system of claim 14, wherein the user interface module further determines the potential source language and the potential target language based on a web browser language setting at the user device.
